(19) United States
(12) Patent Application Publication
(10) Pub. No.: US 2026/0014724 A1
(43) Pub. Date: Jan. 15, 2026

(54) CUTTER WITH A GUIDING PORTION

(71) Applicant: INDUSTRO INTERNATIONAL CO., LTD., Taichung City (TW)

(72) Inventor: KUO-CHAN HUANG, Taichung City (TW)

(21) Appl. No.: 18/772,238

(22) Filed: Jul. 14, 2024

(51) Int. Cl. B26B 29/06

(52) U.S. Cl. CPC B26B 29/06

(57) ABSTRACT

A cutter includes a handle, a blade and a guiding portion. The handle includes a front end, a rear end and a butt extending from the rear end. The blade includes a tip. The handle is movably inserted in the blade so that so that the tip is movable in or from front end of the handle. The guiding portion extends from the butt and includes a convex rim formed between two lateral faces. One of the lateral faces is operable to slide on side of a ruler to allow the convex rim and the blade to move rectilinearly so that the tip cuts a rectilinear seam in a workpiece.

### BACKGROUND OF INVENTION

### 1. Field of Invention

The present invention relates to a cutter and, more particularly, to a cutter with a guiding portion for rectilinear cutting.

### 2. Related Prior Art

There are various cutters for various workpieces. For example, a box cutter (or “utility knife”) is useful in cutting boxes, pieces of paper and tapes for instance.

The box cutter includes a blade movably inserted in a handle so that a tip of the handle is movable in or from a front end of the handle. The handle is operable to move the tip of the blade to cut a seam in a workpiece.

In operation, a user uses a hand to hold the handle to press the tip of the blade on the workpiece. A rear end of the handle is located high above the workpiece. In rectilinear cutting, the tip of the blade is located against a side of a ruler. However, the user might shake the handle and cut an irregular seam in the workpiece because the rear end of the handle is not guided by the side of the ruler. Moreover, the tip of the blade might cut the ruler.

The present invention is therefore intended to obviate or at least alleviate the problems encountered in the prior art.

### SUMMARY OF INVENTION

It is the primary objective of the present invention to provide a reliable cutter.

To achieve the foregoing objective, the cutter includes a handle, a blade and a guiding portion. The handle includes a front end, a rear end and a butt extending from the rear end. The blade includes a tip. The handle is movably inserted in the blade so that the tip is movable in or from front end of the handle. The guiding portion extends from the butt and includes a convex rim formed between two lateral faces. One of the lateral faces is operable to slide on side of a ruler to allow the convex rim and the blade to move rectilinearly so that the tip cuts a rectilinear seam in a workpiece.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a side view of a cutter according to the preferred embodiment of the present invention;

FIG. 2 is a front view of the cutter shown in FIG. 1; and

FIG. 3 is a cross-sectional view of the cutter shown in FIG. 1.

### DETAILED DESCRIPTION OF PREFERRED EMBODIMENT

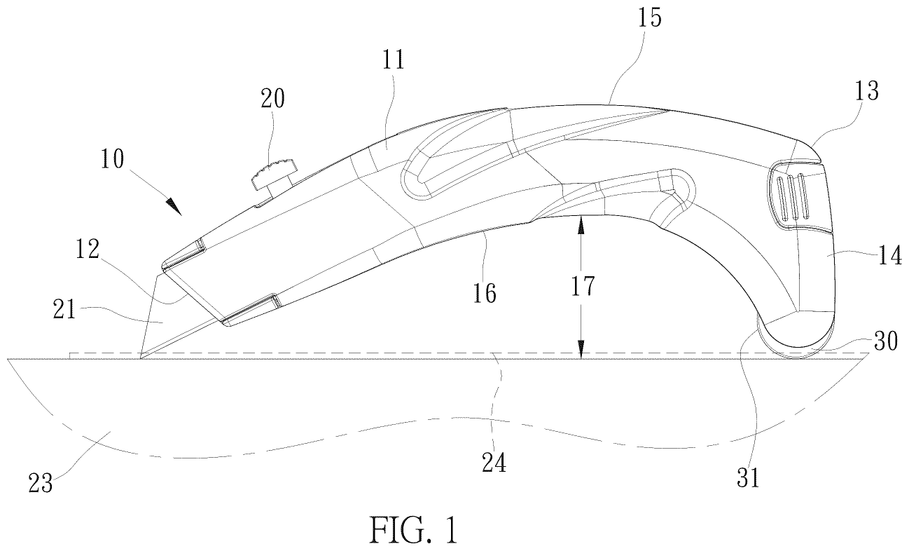

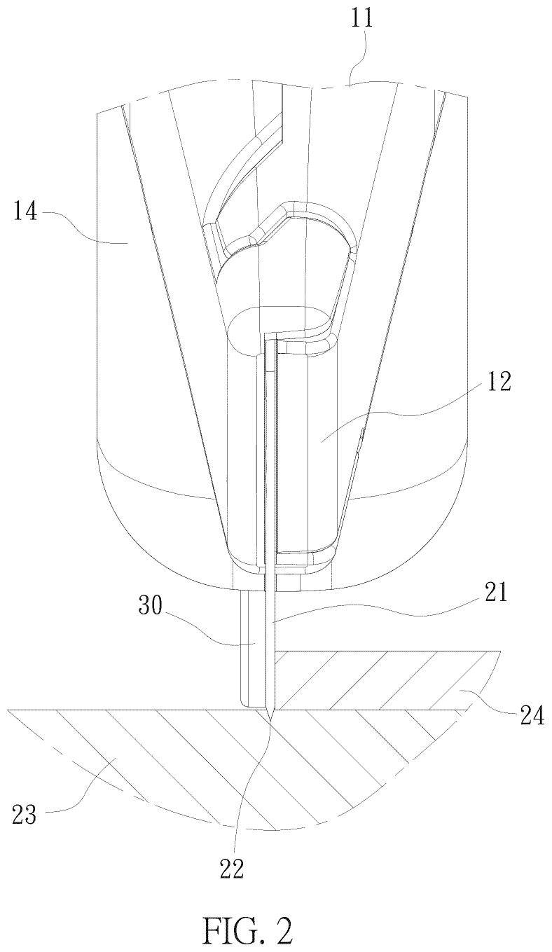

Referring to FIGS. 1 through 3, a cutter 10 includes a handle 11, a blade 21 and a guiding portion 30 according to the preferred embodiment of the present invention. The handle 11 is hollow and includes a front end 12, a rear end 13, an upper portion 15 and a lower portion 16. The handle 11 includes a butt 14 at the rear end 13. The butt 14 renders the handle 11 L-shaped.

The blade 21 includes two tips 22 and two lateral faces 28. The blade 21 is movably inserted in the handle 11. A pusher 20 includes an upper portion movable on the handle 11 and a lower portion connected to the handle 11. The pusher 20 is operable to move the blade 21 relative to the handle 11. Both the tips 22 are located in the handle 11 when the cutter 10 is in an idle position. One of the tips 22 is moved from the handle 11 when the cutter 10 is in an operative position.

The guiding portion 30 includes a convex rim 31 formed between two lateral faces 32. The guiding portion 30 extends down from the butt 14. The guiding portion 30 is narrower than the butt 14 but wider than the blade 21.

In a cutting task, a ruler 24 is placed on a workpiece 23. The guiding portion 30 is placed beneath the workpiece 23 to increase the height of the butt 14 over the workpiece 23. An operative one of the tips 22 is located out of front end 12 of the handle 11 so that the operative tip 22 can be in contact with the workpiece 23. Now, the handle 11 is like an arch on the workpiece 23. The upper portion 15 of the handle 11 is convex. The lower portion 16 of the handle 11 is concave. Thus, a point of the lower portion 16 is at an adequate height 17 above the workpiece 23. Thus, the workpiece 23 does not interfere with a hand (not shown) that holds the handle 11 of the cutter 10.

In operation, the lateral faces 28 of the blade 21 and the lateral faces 32 of the guiding portion 30 are in contact with a side 25 of the ruler 24. The side 25 of the ruler 24 facilitates the blade 21 in rectilinear cutting. Thus, risks of irregular cutting due to human errors are reduced.

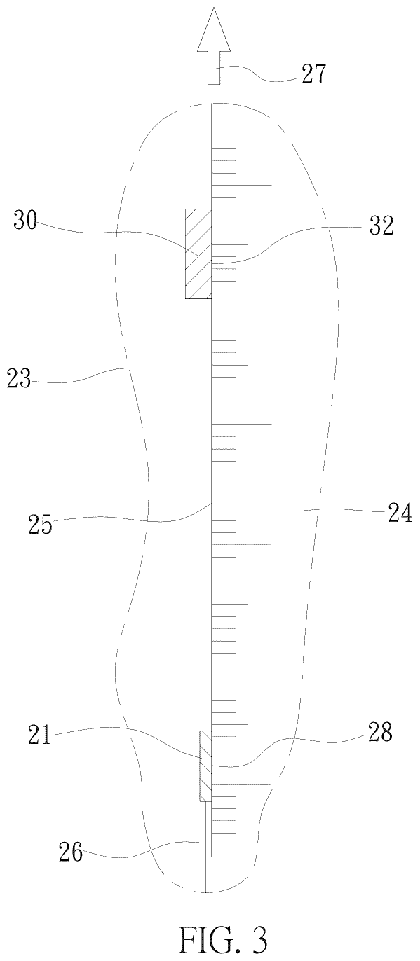

It is to be noted that the guiding portion 30 is stationary relative to the butt 14. The convex rim 31 slides on the workpiece 23 in a rectilinear path as indicted with an arrow head 27 (FIG. 3) so that the operative tip 22 smoothly cuts a rectilinear seam 26 in the workpiece 23.

In other words, one of the lateral faces 32 slides against the side 25 of the ruler 24 to enable the convex rim 31 and the blade 21 to move in the rectilinear path. Hence, the operative tip 22 cut the rectilinear seam 26 in the workpiece 23.

The cutter 10 can be a box cutter or a utility knife for example. The workpiece 23 can be a piece of paper, a box, a tape or any other proper flat object. The guiding portion 30 is used with the blade 21 to enable the workpiece 23 to cut the rectilinear seam 26 in the workpiece 23.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A cutter comprising:
a handle comprising a front end, a rear end, and a butt extending from the rear end;
a blade comprising a tip, wherein the handle is movably inserted in the blade so that the tip is movable in or from front end of the handle; and
a guiding portion extending from the butt and comprising two lateral faces and a convex rim formed between the lateral faces, wherein one of the lateral faces is operable to slide on side of a ruler to allow the convex rim and the blade to move rectilinearly so that the tip cuts a rectilinear seam in a workpiece.

2. The cutter according to claim 1, wherein the guiding portion is not rotational relative to the butt.
